(19) United States
(12) Patent Application Publication
(10) Pub. No.: US 2015/0217539 A1
(43) Pub. Date: Aug. 6, 2015

(54) WORKPIECE OR MATERIAL WITH INERT MARKER SYSTEM

(71) Applicant: Polysecure GmbH, Freiburg (DE)

(72) Inventors: Thomas Baque, Freiburg (DE); Jochen Moesslein, Freiburg (DE)

(73) Assignee: Polysecure GmbH a corporation

(21) Appl. No.: 14/425,057

(22) PCT Filed: Sep. 9, 2013
(86) PCT No.: PCT/DE2013/100318

§ 371 Date: Mar. 2, 2015

(30) Foreign Application Priority Data
Sep. 7, 2012 (DE) 10 2012 017 710.0

(51) Int. Cl. B32B 17/06; B32B 3/10

(52) U.S. Cl. CPC B32B 17/068; B32B 3/10; B32B 2260/04; B32B 2264/104

(57) ABSTRACT

The present invention relates to a workpiece or a material containing a marking agent which comprises a marker in a molten carrier containing boric acid or borax.

### TECHNICAL FIELD

The present invention relates to a workpiece or a material containing a marking agent.

### BACKGROUND

It is known that technical and other high-value products are frequently copied illicitly. In the process, the companies concerned and also the economy as a whole suffer a great loss. Furthermore, the copied products are often of poor quality. Since the customer is not aware of the fact that it is a counterfeit, he projects any defects regarding the low quality onto the brand; so that the manufacturers suffer enormous damage to their image.

Thanks to technical advances, many products produced in series, such as plastic parts, machinery parts and items of clothing, can nowadays be copied virtually perfectly, at least macroscopically. It is therefore often difficult, if not impossible, in many cases to distinguish original products from counterfeit goods, so that original products have to be specially marked with additional features in an effective and economical manner, in order to distinguish them.

In this context, it may be necessary to apply these features not only on the surface of a workpiece or material, such as in the form of labels, but also to incorporate corresponding features into substantially the entire mass of an item and to detect them by means of various measuring methods. A variety of marking agents are known which can be blended into the mass of a material to be marked in order preferably to produce a correspondingly marked workpiece from it.

Among other things, various optical markers are described in the state of the art, and also metallic particles, ferrites and magnetic particles. These markers are blended into the entire mass of the material as an additive.

For these markers, it is of great importance that they do not migrate in the material or workpiece and that they behave inertly even when the material or workpiece is subjected to great stress. This is of very great importance especially in the case of everyday commodities, toys, pharmaceuticals or plant protection agents.

The markers known in the state of the art only satisfy these requirements inadequately, however. Markers are known, for example, which can be dissolved by acids, lyes or solvents, so that the marker substances used in that marking system can easily be dissolved out. In other cases, marker substances can act as catalysts and as a result trigger unwanted reactions, such as curing reaction resins provided with markers even before the planned use, or premature ageing of products.

### SUMMARY

It is therefore an object of the present invention to provide a workpiece or material which can be used as matrices in MALDI mass spectrometry and which contains a marking agent and overcomes the disadvantages from the state of the art described above. In particular, it is intended to provide the marking agent in the workpiece or material in a reliable and poorly soluble form, but without making the markers contained ineffective. In particular, it is intended that during the manufacture of the marking agent, the markers contained therein should not be destroyed or dissolved, and that their security features should not be altered or rendered illegible. In addition, the features of the marking agent should not be influenced in any way during manufacture of the workpiece or material containing it.

### DETAILED DESCRIPTION

This object is achieved by a workpiece or material containing a marking agent which comprises a marker in a molten carrier containing boric acid or borax.

It is preferred in this connection that the marking agent is mixed homogeneously in the workpiece or material.

In addition, a workpiece or material is preferably provided wherein the marker is mixed homogeneously in the carrier.

It is preferred in accordance with the invention for the carrier to be made of glass, ceramics or enamel.

In a further embodiment of the invention, the workpiece or material is preferably characterised by the fact that the marker contains an anti-Stokes pigment and/or a Stokes pigment.

In addition, it is contemplated that the workpiece or material is preferably made of metal, glass, ceramics, wood and/or plastic.

Finally, it is preferably contemplated in accordance with the invention that the weight ratio of marker:carrier is 1:1-1:10, preferably 1:2-1:5.

It has surprisingly been found in accordance with the invention that a marking agent containing a carrier based on boric acid or borax can be successfully incorporated into the mass of a workpiece or material, so that the marker contained in the carrier is present in the carrier in “vitrified” form, as it were, after fusing with the carrier, so that it does not migrate and is altogether inert, but when detected and read out, the features of the marking are not altered, destroyed, dissolved or rendered illegible.

The carrier is particularly preferably an enamel or ceramic glaze frit and particularly preferably contains borax (sodium tetraborate). The carriers to be selected in accordance with the invention are commercially available. The markers can be mixed into those carrier materials and then molten. Depending on the carrier material or markers used, further additives can be added during the manufacture of the marking agent, such as additives that change the melting point of the carrier material or its viscosity. Known additives are, for example, fluorspar, borax, boric acid or alkali carbonates.

The melting to manufacture the marking agent may be performed continuously or discontinuously in furnaces. The appropriate furnaces and any crucibles required are likewise known in the art.

The melts produced can be quenched by pouring them into water or passing them over chilled metal rolls.

The cooled melts obtained can then be processed into a powder with a particle size suitable for the application. Appropriate grinding methods are likewise known to the person skilled in the art.

Further advantages and features of the invention will become clear from the following detailed description with reference to a preferred embodiment.

### Comparative Example

Yttrium oxisulphide, doped with terbium and erbium oxide, is an anti-Stokes pigment which can be used as a marker. This marker can be excited with radiation of a suitable wavelength, and its fluorescence effects can be detected with an appropriate detector, such as a simple imaging camera.

This marker has only limited resistance to acid, such as diluted hydrochloric acid, so that there is a risk that the yttrium could be converted into a bio-available compound. This is not only undesirable from the medical point of view, but is also prohibited in everyday consumer goods and children's toys, cf. DIN EN 71.

### EXAMPLE

The pigment described above was mixed with a boron frit, such as M9358 (Ferro, Reimbold & Strick), in a ratio of 1:2 to 1:5. The mixture was melted at 1000° C. and the melt obtained was then quenched by pouring into water. The glass obtained does not exhibit any solubility of the yttrium, while the anti-Stokes effect is nevertheless retained.

The features of the invention disclosed in the above description and in the claims can be essential to implementing the invention in its various embodiments both individually and in any combination.

1. A workpiece or material containing a marking agent which comprises a marker in a molten carrier containing boric acid or borax.

2. The workpiece or material as claimed in claim 1, characterised in that the marking agent is mixed homogeneously in the workpiece or material.

3. The workpiece or material as claimed in claim 1, characterised in that the marker is mixed homogeneously in the carrier.

4. The workpiece or material as claimed in claim 1, characterised in that the carrier is glass, ceramics or enamel.

5. The workpiece or material as claimed in claim 1, characterised in that the marker contains an anti-Stokes pigment and/or a Stokes pigment.

6. The workpiece or material as claimed in claim 1, characterised in that the workpiece or material is made of metal, glass, ceramics, wood and/or plastic.

7. The workpiece or material as claimed in claim 1, characterised in that the weight ratio of marker:carrier is 1:1-1:10.

8. The workpiece or material as claimed in claim 2, characterised in that the marker is mixed homogeneously in the carrier.

9. The workpiece or material as claimed in claim 2, characterised in that the carrier is glass, ceramics or enamel.

10. The workpiece or material as claimed in claim 3, characterised in that the carrier is glass, ceramics or enamel.

11. The workpiece or material as claimed in claim 2, characterised in that the marker contains an anti-Stokes pigment and/or a Stokes pigment.

12. The workpiece or material as claimed in claim 3, characterised in that the marker contains an anti-Stokes pigment and/or a Stokes pigment.

13. The workpiece or material as claimed in claim 4, characterised in that the marker contains an anti-Stokes pigment and/or a Stokes pigment.

14. The workpiece or material as claimed in claim 2, characterised in that the workpiece or material is made of metal, glass, ceramics, wood and/or plastic.

15. The workpiece or material as claimed in claim 3, characterised in that the workpiece or material is made of metal, glass, ceramics, wood and/or plastic.

16. The workpiece or material as claimed in claim 4, characterised in that the workpiece or material is made of metal, glass, ceramics, wood and/or plastic.

17. The workpiece or material as claimed in claim 5, characterised in that the workpiece or material is made of metal, glass, ceramics, wood and/or plastic.
